(19) United States
(12) Patent Application Publication
(10) Pub. No.: US 2023/0419364 A1
(43) Pub. Date: Dec. 28, 2023

(54) PUSHED NOTIFICATIONS IN MOBILE COMMUNICATIONS

(71) Applicant: Truist Bank, Charlotte, NC (US)

(72) Inventors: Alex Heath Misiaszek, Cornelius, NC (US); Sarah Katherine Nash, Raleigh, NC (US)

(73) Assignee: Truist Bank, Charlotte, NC (US)

(21) Appl. No.: 17/847,937

(22) Filed: Jun. 23, 2022

(51) Int. Cl. G06Q 30/02; H04W 4/12; H04W 4/021; H04W 4/029

(52) U.S. Cl. CPC G06Q 30/0261; G06Q 30/0207; H04W 4/12; H04W 4/021; H04W 4/029

(57) ABSTRACT

A system described herein can notify a user of promotional offers based on a location of the user. For example, the system can include a geolocation device positionable to track the location of the user. The system can also include a processor and a memory that includes instructions executable by the processor for causing the processor to perform operations. The operations can include receiving a promotional offer associated with a promotional retailer. The operations can also include tracking a user based on a location of the geolocation device. Further, the operations can include detecting the user in a vicinity of the promotional retailer. The operations can also include notifying the user of the promotional offer associated with the retailer.

### TECHNICAL FIELD

The present disclosure relates generally to mobile communications and, more particularly (although not necessarily exclusively), to pushed notifications in mobile communications or wearables.

### BACKGROUND

A rewards program can include techniques aimed at helping institutions retain their customer base. In an example, a strategy for implementing the rewards program can include offering users contextual recommendations or rewards at participating institutions. Presenting savings recommendations or offers on a timely basis is valuable to both the business and the users—it can motivate users by saving them time and money while also helping promote products for a business.

### SUMMARY

A system described herein can notify a user of promotional offers based on a location of the user. For example, the system can include a geolocation device positionable to track the location of the user. The system can also include a processor and a memory that includes instructions executable by the processor for causing the processor to perform operations. The operations can include receiving a promotional offer associated with a promotional retailer. The operations can also include tracking a user based on a location of the geolocation device. Further, the operations can include detecting the user in a vicinity of the promotional retailer. The operations can also include notifying the user of the promotional offer associated with the retailer.

In another example, a method described herein can include receiving a promotional offer associated with a promotional retailer. The method can also include tracking a user based on a location of a geolocation device. Further, the method can include detecting the user in a vicinity of the promotional retailer. The method can also include notifying the user of the promotional offer associated with the promotional retailer.

In an example, a non-transitory computer-readable medium includes instructions that are executable for causing the processor to perform operations including receiving a promotional offer associated with a promotional retailer. The operations can also include tracking a user based on a location of a geolocation device. Further, the operations can include detecting the user in a vicinity of the promotional retailer. The operations can further include notifying the user of the promotional offer associated with the promotional retailer.

### BRIEF DESCRIPTION OF THE DRAWINGS

FIG. 1 is a schematic of a retail environment for notifying a user of a promotional offer based on geolocation tracking of the user according to one example of the present disclosure.

FIG. 2 is a depiction of an example of a geolocation device receiving a notification of a promotional offer based on geolocation tracking of a user according to one example of the present disclosure.

FIG. 3 is a flowchart of a process for notifying a user of a promotional offer based on geolocation tracking of the user according to one example of the present disclosure.

FIG. 4 is a flowchart of an alternate process for notifying a user of a promotional offer based on geolocation tracking of the user according to one example of the present disclosure.

FIG. 5 is a depiction of an additional example of a geolocation device receiving a notification of a promotional offer based on geolocation tracking of a user according to one example of the present disclosure

FIG. 6 is a block diagram of a computing device for notifying a user of a promotional offer based on geolocation tracking of the user according to one example of the present disclosure.

### DETAILED DESCRIPTION

Certain aspects and examples of the present disclosure relate to tracking a user with a geolocation device and notifying the user of promotional offers when the user is in a vicinity of a promotional retailer. Geolocation can refer to a use of location technologies such as Global Positioning System (GPS) or Internet Protocol (IP) addresses to identify and track whereabouts of connected electronic devices. A device's whereabouts can also be tracked via cell phone towers, WiFi access points, fixed location Bluetooth low energy (BLE) beacons, etc., or any combination of these. Examples of geolocation devices include wearable technology like smart watches, mobile devices like smartphones, navigational footwear, GPS trackers, vehicle trackers, mini GPS trackers, laptops, etc.

A promotional retailer can provide a promotional amount and geolocations of stores in exchange for a notification system pushing notifications to the user of promotional offers when the user is in the vicinity of any of the stores. The vicinity of a promotional retailer can include a boundary of a parking lot of a store, the front entrance of the store, a street intersection adjacent to the store, etc. In some examples, a computing device can track the user based on the location of the geolocation device. The computing device can also track a velocity vector for the user. The computing device can send a notification of promotional offers associated with the promotional retailer to the user when the user enters the vicinity of the promotional retailer. The notification can be sent through the geolocation device. In an example, the promotional offer may be provided by a credit card through enhanced cash back percentages for varying retailer categories (e.g., gas, restaurants, groceries, etc.), or the promotional offer may be a cash back rebate for a particular store (e.g., $5 off of a purchase at a particular store when the purchase price exceeds $25). Further, the promotional retailer may include a credit card company offering the rebates, or the promotional retailer may include a specific store that provides the rebates.

In some examples, the computing device can predict a trajectory of the user based on at least one of: the location of the geolocation device, the velocity vector, or historical geolocation data for the user. In some examples, the computing device can use historical geolocation data for the user to train a machine-learning model to predict trajectories for the user. Historical geolocation data can include previous location data, previous velocity vector data, or a combination of both. In some examples, the predicted trajectory can lead to the vicinity of the promotional retailer. In this case, the computing device can notify the user of promotional offers immediately after determining that the trajectory will lead to the vicinity of the promotional retailer. The computing device does not need to wait until the user enters the vicinity to send the notification.

Users can be notified of promotional offers in real time while they are shopping at participating retailers. The notifications can provide convenience for the user and save the user time. Users can appreciate receiving promotional offers tailored to their needs and choose to remain with a bank.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

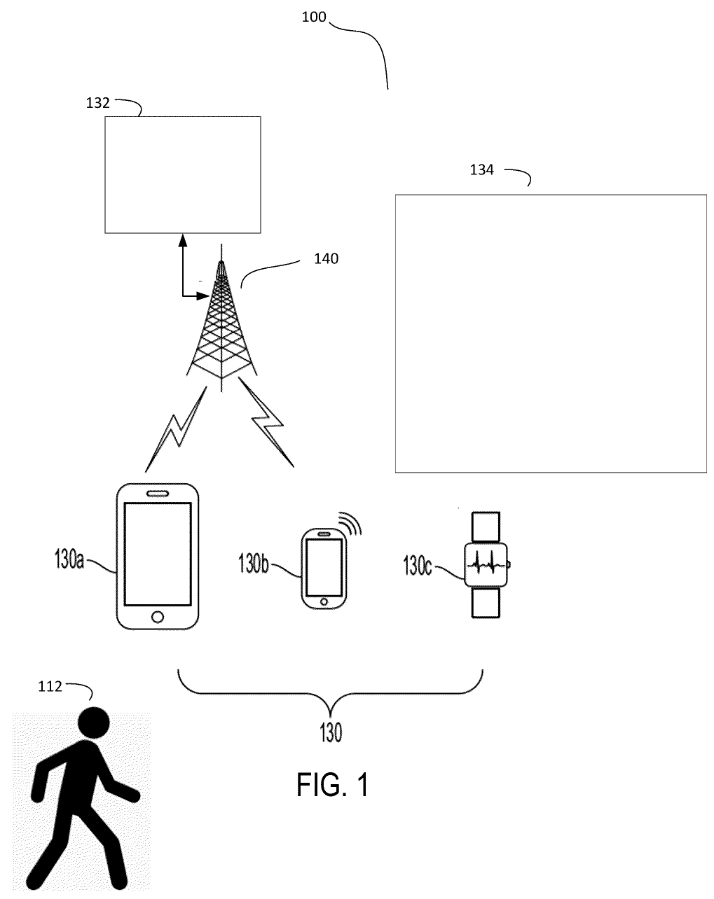

FIG. 1 is a schematic of a retail environment 100 for notifying a user 112 of a promotional offer based on a geolocation tracking of the user 112 according to one example of the present disclosure. Included in the retail environment 100 are the user 112, one or more geolocation devices 130, one or more communication networks 140, a promotional retailer 134, and a computing device 132. The one or more geolocation devices 130 and the promotional retailer 134 may send or receive communication with the computing device 132 over the one or more communication networks 140. The one or more communication networks 140 may correspond to one or more Wide Area Networks (“WANs”), such as the internet, through which the one or more geolocation devices 130, the promotional retailer 134, and the computing device 132 may communicate with servers via web browsers or client-side operations, to establish communications, request and receive web-based resources, and access other features of applications or services. Although illustrated as being within the location of the retail environment 100, the computing device 132 can be situated in a remote location away from the retail environment 100.

The one or more geolocation devices 130, which can include suitable geolocation devices for accessing web-based resources or application-based resources, can be capable of accessing and establishing communication sessions with the computing device 132 through the one or more communication networks 140. As illustrated in FIG. 1, geolocation devices 130a-130c correspond to mobile devices, including tablet computers 130a, smartphones 130b, and smart watches 130c, which may access the computing device 132 via a Local Area Network (“LAN”) or Wide Area Network (“WAN”), as well as mobile telecommunication networks, short-range wireless networks, or various other communication network types (e.g., cable or satellite networks). Other examples of geolocation devices 130 (not shown) can include GPS trackers, vehicle trackers, mini GPS trackers, navigational footwear, other forms of wearable technology, etc., or any combination of these. Although certain examples herein are described in terms of mobile devices, in other examples, the one or more geolocation devices 130 may additionally or alternatively include other mobile or non-mobile devices (e.g., desktop computers, laptop computers, and the like) capable of accessing the computing device 132 via the one or more communication networks 140.

The one or more geolocation devices 130 can provide the location of the one or more geolocation devices 130 to the computing device 132, allowing the computing device 132 to track the user 112. The computing device 132 can determine, based on the location, if the user enters a vicinity of the promotional retailer 134. When the user enters the vicinity, the computing device 132 can notify the user 112 of a promotional offer. The computing device 132 can send the notification to the one or more geolocation devices 130. The notification can include an audio alert, a vibrational alert, a text message, a message alert, etc., or some combination of these.

The one or more geolocation devices 130 can also provide a velocity vector to the computing device 132. The computing device 132 can log, record, and save the location and velocity vector received from the one or more geolocation devices 130. The saved locations and velocity vectors can become historical geolocation data that can be used by the computing device to train a machine-learning model. The trained machine-learning model can predict a trajectory for the user 112.

There can be more than one geolocation device associated with the user 112. Conversely, each of the one or more geolocation devices 130 can be associated with more than one user 112. For example, a geolocation device could be a vehicle tracker. A vehicle can have more than one passenger. Thus, the vehicle tracker can provide locations of multiple users.

The promotional retailer 134 can provide promotional offers to the computing device 132. The types of promotional offers can vary by time of year, geographic location, and characteristics of the user 112. The promotional retailer 134 can also provide to the computing device 132 geolocations of stores associated with the promotional retailer 134. The promotional retailer 134 can also provide the computing device 132 with an amount of payment as compensation for notifying the user 112 of the promotional offers. The amount can depend on factors including proximity of competing retailers, time of day, seasonal factors, type of item offered, regional factors, etc., or a combination of these factors.

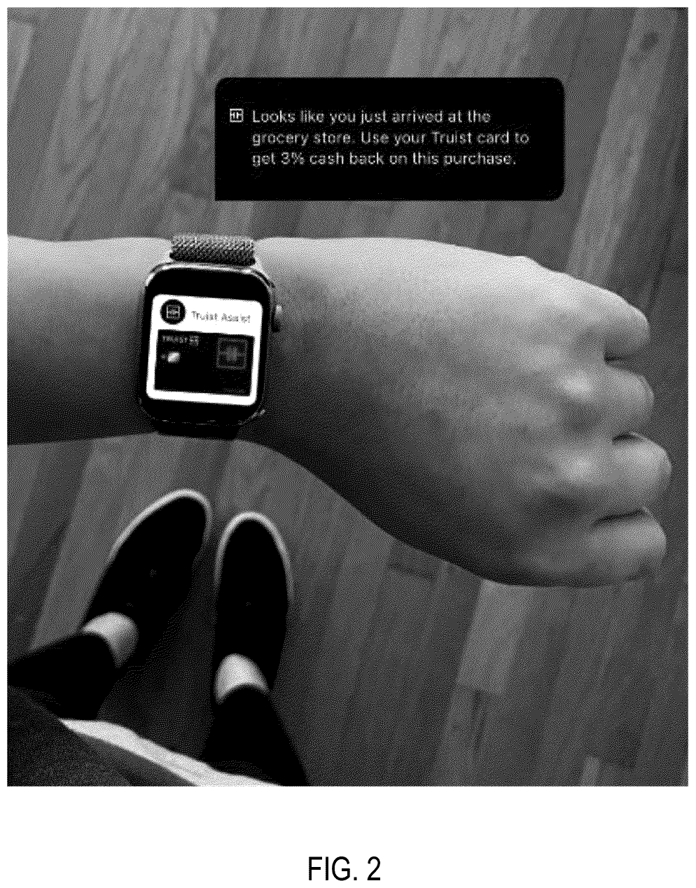

FIG. 2 is a photograph of a geolocation device receiving a notification of a promotional offer based on geolocation tracking of a user 112 according to one example of the present disclosure. The notification can include more than one promotional offer. If the user 112 enters vicinities of different promotional retailers, the user 112 can receive notification of the promotional offers from both promotional retailers. The promotional offers selected for notification can reflect the transaction history and spending habits of the user 112.

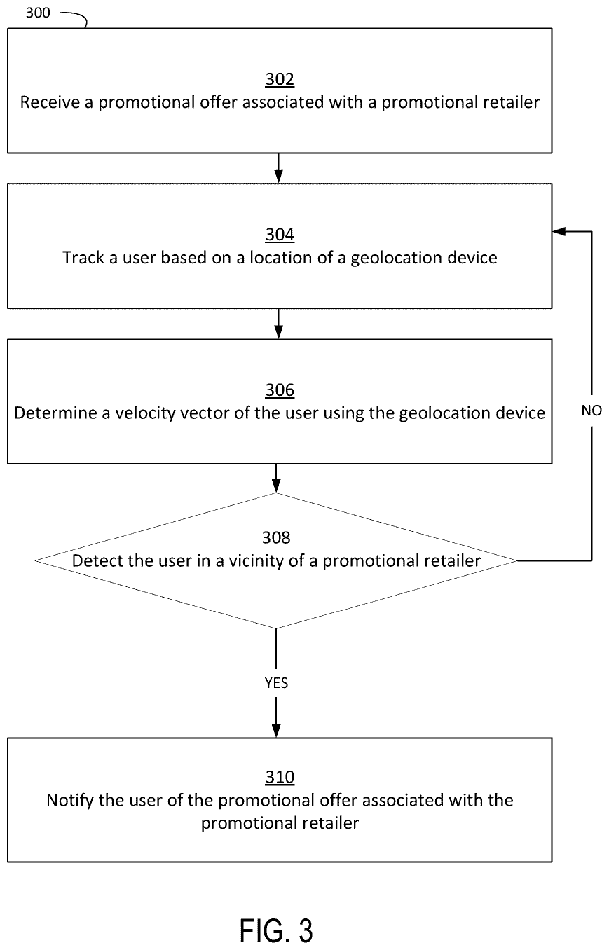

FIG. 3 is a flowchart of a process 300 for notifying a user 112 of a promotional offer based on geolocation tracking of the user 112 according to one example of the present disclosure. Operations of flowcharts may be performed by software, firmware, hardware, or a combination thereof. The operations of the flowchart start at block 302.

At block 302, the process 300 involves receiving a promotional offer associated with a promotional retailer 134. The promotional offer can be sent to a computing device 132. There can be more than one promotional offer. In some examples, the promotional retailer 134 can provide a geolocation of at least one store associated with the promotional retailer 134. The computing device 132 can determine a vicinity associated with the promotional retailer 134 based on the geolocation. In some examples, the promotional retailer 134 can provide an amount of payment to a provider of the notifications to the user 112. The amount of payment can compensate the notification provider for notifying a user 112 of the promotional offer. The amount can depend on factors including proximity of competing retailers, time of day, seasonal factors, regional factors, etc., or a combination of these factors.

At block 304, the process 300 involves tracking the user 112 based on a location of a geolocation device 130. The location of the user 112 can coincide with the location of the geolocation device 130. In some examples, there is a known relationship between the location of the user 112 and the location of the geolocation device. The geolocation device can include wearable technology such as a smartwatch, a smart phone, a tablet computer, navigational footwear, GPS trackers, vehicle trackers, mini GPS trackers, laptops, etc. There can be more than one geolocation device 130 associated with the user 112. In some examples, there can be more than one user 112 associated with each geolocation device 130. For example, the geolocation device 130 could be a vehicle tracker. There can be more than one passenger in a vehicle and the location of the vehicle tracker would determine the location of all passengers in the vehicle.

At block 306, the process 300 involves determining a velocity vector of the user 112 using the geolocation device 130. The computing device 132 can determine the velocity vector from a series of location data of the geolocation device 130 as well as the time stamps associated with the data. The computing device 132 can record and store both the location of the user 112 and the velocity vector as functions of time. The location and velocity vector data can contribute to historical geolocation data of the user 112.

At block 308, the process 300 involves detecting whether the user 112 is in the vicinity of the promotional retailer 134. The vicinity can be predetermined and based on the geolocation of the at least one store associated with the promotional retailer 134. In some examples, the vicinity can be defined as a radius around a store or the boundaries of a store parking lot. An example of the vicinity can include intersections that are near the store.

The computing device 132 can check the location of the user 112 to see if the user 112 has entered the vicinity of the promotional retailer 134. If the user 112 has entered the vicinity, the process 300 progresses to block 310. If the user 112 has not entered the vicinity, the process 300 returns to block 304 and repeats steps of the process.

At block 310, the process 300 involves notifying the user 112 of the promotional offer associated with the promotional retailer 134. In some examples, the notification can be pushed to the one or more geolocation devices 130. Notifying the user can include sending to the geolocation device 130 an audio alert, a vibrational alert, a text message, a message alert, or some combination of these.

In some examples, the computing device 132 selects the promotional offer based on the user transaction history. For example, the promotional retailer 134 can be a barbershop and the promotional offer can be a coupon on a haircut. The computing device can use past frequency of haircut transactions of the user 112, as indicated in account transactions from the user's bank, to determine whether to notify the user 112 of the haircut rebate. For example, if the user 112 typically purchases a haircut every three months and it has been three days since the last haircut transaction, the computing device 132 can choose not to notify the user 112 of the promotional offer in this case. Conversely, if it has been five months since the most recent haircut, the computing device 132 can prioritize the promotional offer and notify the user 112 of the rebate.

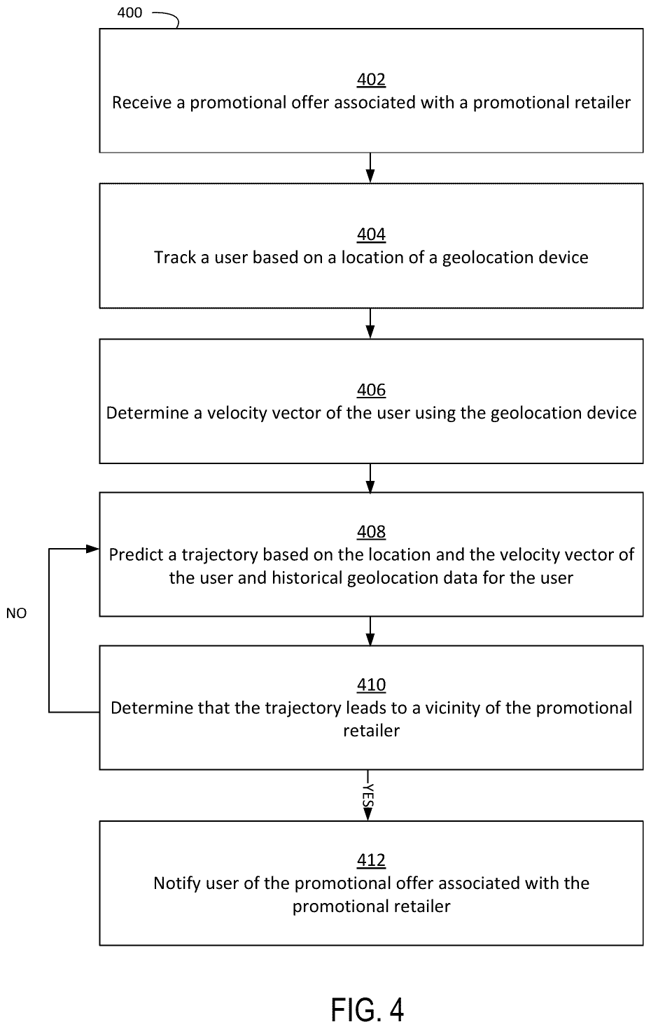

FIG. 4 is a flowchart of an alternate process 400 for notifying a user 112 of a promotional offer based on geolocation tracking of the user 112 according to one example of the present disclosure. Operations of flowcharts may be performed by software, firmware, hardware, or a combination thereof. The operations of the flowchart start at block 402.

At block 402, the process 400 involves receiving a promotional offer associated with a promotional retailer 134. The promotional offer can be sent to a computing device 132. There can be more than one promotional offer. In some examples, the promotional retailer 134 can provide a geolocation of at least one store associated with the promotional retailer 134. The computing device 132 can determine a vicinity associated with the promotional retailer 134 based on the geolocation. In some examples, the promotional retailer 134 can provide an amount of payment to a provider of the notifications to the user 112. The amount of payment can compensate the notification provider for notifying a user 112 of the promotional offer. The amount can depend on factors including proximity of competing retailers, time of day, seasonal factors, regional factors, etc., or a combination of these factors.

At block 404, the process 400 involves tracking the user 112 based on a location of a geolocation device 130. The location of the user 112 can coincide with the location of the geolocation device 130. In some examples, there is a known relationship between the location of the user 112 and the location of the geolocation device. The geolocation device can include wearable technology such as a smartwatch, a smart phone, a tablet computer, navigational footwear, GPS trackers, vehicle trackers, mini GPS trackers, laptops, etc. There can be more than one geolocation device 130 associated with the user 112. In some examples, there can be more than one user 112 associated with each geolocation device 130.

At block 406, the process 400 involves determining a velocity vector of the user 112 using the geolocation device 130. The computing device 132 can determine the velocity vector from a series of location data of the geolocation device 130 as well as the time stamps associated with the data. The computing device 132 can record and store both the location of the user 112 and the velocity vector as functions of time. The location and velocity vector data can contribute to historical geolocation data of the user 112.

At block 408, the process 400 involves predicting a trajectory based on the location and velocity vector of the user 112 and the historical geolocation data of the user 112. In some examples, the computing device 132 can train a machine-learning model. Training data for the model can include the historical geolocation data of the user 112. The trained machine-learning model can produce the trajectory prediction based on at least one of: the location of the geolocation device, the velocity vector, or the historical geolocation data. The trajectory represents the predicted path of the user 112.

At block 410, the process 400 involves determining that the trajectory leads to the vicinity of the promotional retailer 134. The vicinity can be predetermined and based on the geolocation of the at least one store associated with the promotional retailer 134. In some examples, the vicinity can be defined as a radius around a store or the boundaries of a store parking lot. An example of the vicinity can include intersections that are near the store.

The computing device 132 can determine if the predicted trajectory intersects the vicinity of the promotional retailer 134. If the trajectory terminates at or intersects the vicinity, the process 400 progresses to block 412. If the trajectory never intersects the vicinity, the process 400 returns to block 408 and the process continues.

At block 412, the process 400 involves notifying the user 112 of the promotional offer associated with the promotional retailer 134. In some examples, the notification can be pushed to the one or more geolocation devices 130. Notifying the user can include sending to the geolocation device 130 an audio alert, a vibrational alert, a text message, a message alert, or some combination of these. In some examples, the computing device 132 selects the promotional offer based on the user transaction history.

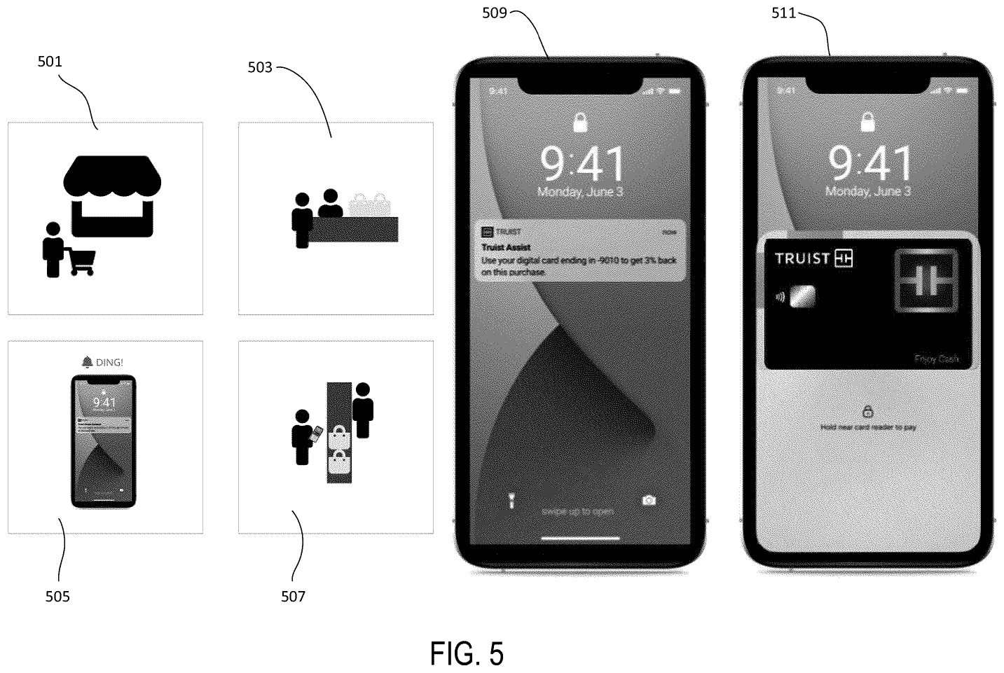

FIG. 5 is a depiction of an additional example of a geolocation device receiving a notification of a promotional offer based on geolocation tracking of a user according to one example of the present disclosure. A geolocation device can detect a user entering a vicinity of a promotional retailer as shown in image 501. A notification can be sent to the user informing the user of a promotional offer or savings recommendation associated with the promotional retailer. In some examples, the notification can include a push notification to the geolocation device when the user approaches a checkout counter at the promotional retailer as shown in image 503. As shown in image 505, the push notification may include an audible notification, a haptic notification, or both in addition to content displayed on a screen that provides details of the offer.

Image 509 depicts an enlarged view of an example of the push notification to the geolocation device. In some examples, the geolocation device can include a mobile wallet that stores information associated with credit cards of the user. Each credit card can offer rewards for certain purchase reward categories. Examples of purchase reward categories can include groceries, dining, entertainment, gas, memberships, fitness, and recreation. For example, a credit card in the mobile wallet can offer 5% cash back on grocery purchases. Another credit card in the mobile wallet can offer 7% cash back on gas purchases. The promotional offer can also include cash back rebates for specific promotional retailers (e.g., a specific store) offered by credit cards in the mobile wallet of the user. In some examples, the credit card in the mobile wallet with the highest cash back percentage for the purchase reward category associated with the promotional retailer or the largest cash back rebates for the promotional retailer can be determined. The notification can include a notification of which credit card in the mobile wallet offers the highest cash back percentage or rebate for the promotional retailer.

Image 507 depicts the user completing a transaction at a checkout counter. In some examples, the geolocation device can be used by the user to complete the transaction as shown in the image 507 (e.g., using a mobile wallet storing credit card information on the geolocation device). In some examples, a reminder can be sent to the user that the geolocation device can be used to complete the purchase. In some examples, the reminder can be sent as a push notification to the user. Image 511 depicts an enlarged view of an example of the mobile wallet when use the geolocation device to complete the transaction.

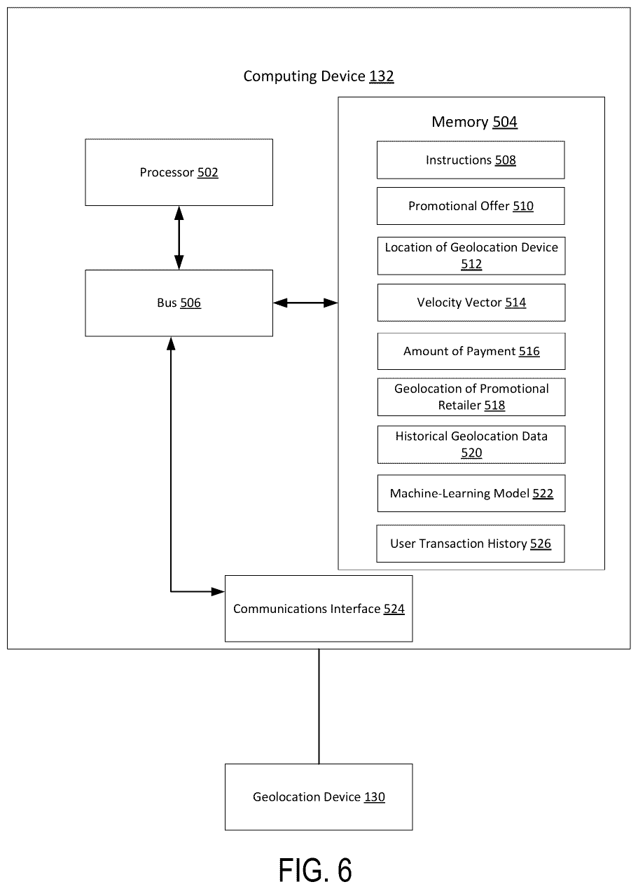

FIG. 6 is a block diagram of a computing device 132 for notifying a user of a promotional offer based on geolocation tracking of the user 112 according to one example of the present disclosure. The components in FIG. 6 such as a processor 502, a memory 504, a bus 506, and the like, may be integrated into a single structure such as within a single housing of the computing device 132. Alternatively, the components shown in FIG. 6 can be distributed from one another and in electrical communication with each other.

As shown, the computing device 132 includes the processor 502 communicatively coupled to the memory 504 by the bus 506. The processor 502 can include one processor or multiple processors. Non-limiting examples of the processor 502 include a Field-Programmable Gate Array (FPGA), an application specific integrated circuit (ASIC), a microprocessor, or any combination of these. The processor 502 can execute instructions 508 stored in the memory 504 to perform operations. In some examples, the instructions 508 can include processor-specific instructions generated by a compiler or an interpreter from code written in any suitable computer-programming language, such as C, C++, C #, or Java.

The memory 504 can include one memory device or multiple memory devices. The memory 504 can be non-volatile and may include any type of memory device that retains stored information when powered off. Non-limiting examples of the memory 504 include electrically erasable and programmable read-only memory (EEPROM), flash memory, or any type of non-volatile memory. At least some of the memory 504 can include a non-transitory computer-readable medium from which the processor 502 can read the instructions 508. The non-transitory computer-readable medium can include electronic, optical, magnetic, or other storage devices capable of providing the processor 502 with the instructions 508 or other program code. Non-limiting examples of the non-transitory computer-readable medium include magnetic disk(s), memory chip(s), RAM, an ASIC, or any other medium from which a computer processor can read instructions.

The computing device 132 also includes the bus 506 (e.g., PCI, ISA, PCI-Express, Hyper-Transport® bus, InfiniBand® bus, NuBus, etc.) and a communications interface 524 (e.g., a Fiber Channel Interface, wireless interface, etc.)

Realizations may include fewer or additional components not illustrated in FIG. 6 (e.g., video cards, audio cards, additional communication interfaces, peripheral devices, etc.) The processor 502 and the communication interface 524 are coupled to the bus 506. Although illustrated as being coupled to the bus 506, the memory 504 may be coupled to the processor 502.

Additionally, the memory 504 can include at least one promotional offer 510, a location of geolocation device 512, a velocity vector 514 for the user 112, an amount of payment 516 from a promotional retailer 134 to the notification provider, a geolocation of the promotional retailer 518, historical geolocation data 520 for the user 112, a machine-learning model, and user transaction history 526. The computing device 132 can receive the promotional offer 510, the amount of payment 516, and the geolocation of the promotional retailer 518 from the promotional retailer 134 by means of the communications interface 524. The computing device 132 may send or receive communication with one or more geolocation devices 130 and the promotional retailer 134 over one or more communication networks 140. The one or more geolocation devices 130 can provide the computing device 132 with the location of the geolocation device 512 and the velocity vector 514. The location of the geolocation device 512 can be used to track the user 112. Data received from the one or more geolocation devices 130 can be stored by the computing device 132 as the historical geolocation data 520.

If the computing device 132 determines that the user 112 has entered a vicinity defined by the geolocation of the promotional retailer 518, the computing device can send the promotional offer 510 to the user 112 through the one or more geolocation devices 130. In some examples, the promotional offer 510 can be chosen based on the user transaction history 526.

In some examples, the computing device 132 can train the machine-learning model 522 using at least one of the following as training data: the location of the geolocation device 512, the velocity vector 514, or historical geolocation data 520. The trained machine-learning model 522 can predict a trajectory for the user 112. The computing device 132 can determine if the trajectory will lead to the vicinity of the promotional retailer 134 and send the promotional offer accordingly.

In some examples, the computing device 132 can implement process 300 and process 400 shown in FIG. 3 and FIG. 4 for effectuating some aspects of the present disclosure. Other examples can involve more operations, fewer operations, different operations, or a different order of the operations shown in FIG. 3 and FIG. 4. The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a geolocation device positionable to track a location of a user;
a processor; and
a memory that includes instructions executable by the processor for causing the processor to:
receive a promotional offer associated with a promotional retailer;
receive a plurality of transmissions from the geolocation device;
determine, based on the plurality of transmissions, a location of the geolocation device;
determine, based on the plurality of transmissions, a velocity vector of the user;
train a machine-learning model to predict trajectories of the user using historical geolocation data of the user;
predict a trajectory of the user by applying the trained machine-learning model to the velocity vector of the user, the location of the geolocation device, and the historical geolocation data for the user;
determine that the trajectory will lead to a vicinity of the promotional retailer; and
immediately upon determining that the trajectory will lead to the vicinity, transmit a notification to the user of the promotional offer associated with the promotional retailer.

2. The system of claim 1, wherein the memory further comprises instructions executable by the processor for causing the processor to:
receive a geolocation of the vicinity of the promotional retailer from the promotional retailer; and
receive an amount of payment from the promotional retailer to transmit the notification to the user of the promotional offer.

3. The system of claim 2, wherein the amount of payment is based on at least one of: proximity of competing retailers, time of day, seasonal factors, type of item offered, or regional factors.

4. The system of claim 1, wherein the memory further comprises instructions executable by the processor for causing the processor to:
determine a purchase reward category associated with the promotional retailer;
determine a credit card in a mobile wallet of the user that offers a greatest incentive for the purchase reward category; and
notify the user of the credit card with the greatest incentive for the purchase reward category.

5. (canceled)

6. (canceled)

7. The system of claim 1, wherein transmitting the notification to the user comprises sending to the geolocation device an audio alert, a vibrational alert, a text message, a message alert, or any combination thereof.

8. A method comprising:
receiving a promotional offer associated with a promotional retailer;
receiving a plurality of transmissions from a geolocation device;
determining, based on the plurality of transmissions, a location of the geolocation device;
determining, based on the plurality of transmissions, a velocity vector of a user;
training a machine-learning model to predict trajectories of the user using historical geolocation data for the user;
predicting a trajectory of the user by applying the trained machine-learning model to the velocity vector of the user, the location of the geolocation device, and the historical geolocation data for the user;
determining that the trajectory will lead to a vicinity of the promotional retailer; and
immediately upon determining that the trajectory will lead to the vicinity, transmitting a notification to the user of the promotional offer associated with the promotional retailer.

9. The method of claim 8, further comprising:
receiving a geolocation of the vicinity of the promotional retailer from the promotional retailer; and
receiving an amount of payment from the promotional retailer to transmit the notification to the user of the promotional offer.

10. The method of claim 9, wherein the amount of payment is based on proximity of competing retailers, time of day, seasonal factors, type of item offered, regional factors, or any combination thereof.

11. The method of claim 8, further comprising:
determining a purchase reward category associated with the promotional retailer;
determining a credit card in a mobile wallet of the user that offers a greatest incentive for the purchase reward category; and
notifying the user of the credit card with the greatest incentive for the purchase reward category.

12. (canceled)

13. (canceled)

14. The method of claim 8, wherein transmitting the notification to the user comprises sending to the geolocation device an audio alert, a vibrational alert, a text message, a message alert, or any combination thereof.

15. A non-transitory computer-readable medium comprising instructions that are executable by a processor for causing the processor to perform operations comprising:
receiving a promotional offer associated with a promotional retailer;
receiving a plurality of transmissions from a geolocation device;
determining, based on the plurality of transmissions, a location of the geolocation device;
determining, based on the plurality of transmissions, a velocity vector for a user;
training a machine-learning model to predict trajectories of the user using historical geolocation data of the user;
predicting a trajectory of the user by applying the trained machine-learning model to the velocity vector of the user, the location of the geolocation device, and the historical geolocation data for the user;
determining that the trajectory will lead to a vicinity of the promotional retailer; and
immediately upon determining that the trajectory will lead to the vicinity, transmitting a notification to the user of the promotional offer associated with the promotional retailer.

16. The non-transitory computer-readable medium of claim 15, wherein the operations further comprise:
receiving a geolocation of the vicinity of the promotional retailer from the promotional retailer; and
receiving an amount of payment from the promotional retailer to transmit the notification to the user of the promotional offer.

17. The non-transitory computer-readable medium of claim 16, wherein the amount of payment is based on at least one of: proximity of competing retailers, time of day, seasonal factors, type of item offered, or regional factors.

18. The non-transitory computer-readable medium of claim 15, wherein the operations further comprise:
determining a purchase reward category associated with the promotional retailer;
determining a credit card in a mobile wallet of the user that offers a greatest incentive for the purchase reward category; and
notifying the user of the credit card that offers the greatest incentive for the purchase reward category.

19. The non-transitory computer-readable medium of claim 15, wherein transmitting the notification to the user comprises sending to the geolocation device an audio alert, a vibrational alert, a text message, a message alert, or any combination thereof.

20. (canceled)
